(19) United States
(12) Patent Application Publication
(10) Pub. No.: US 2026/0270059 A1
(43) Pub. Date: Sep. 10, 2026

(54) PROTECTION SYSTEM AND METHOD FOR A COMPUTER DEVICE

(71) Applicant: Northrop Grumman Systems Corporation, Falls Church, VA (US)

(72) Inventor: Jessica Ascough, Redondo Beach, CA (US)

(21) Appl. No.: 19/072,263

(22) Filed: Mar. 6, 2025

(51) Int. Cl. H04L 9/08

(52) U.S. Cl. CPC H04L 9/088; G06F 21/32; G06F 21/60; G06F 21/602; H04L 9/08; H04L 9/0816; H04L 9/0819; H04L 9/0822; H04L 9/0825; H04L 9/32

(57) ABSTRACT

A system and method to protect encrypted data on a computer device are disclosed in which encrypted data is encrypted using a master encryption key. A controller having a processor and memory architecture is configured to acquire an audio recording using the audio capture device and analyze the audio recording to determine if the audio recording is associated with an authorized user saying a safe word and whether the authorized user said the safe word using a typical vocalization or a unique vocalization. The controller is further configured to delete the master encryption key and transmit a beacon message to an enterprise computer if the audio recording is associated with the authorized user said the safe word using the unique vocalization.

### FIELD OF DISCLOSURE

The present subject matter relates to systems and methods for securing data on a computer device and more particularly, a system and method for protecting data on the computer device and generating a distress beacon when access to the computer device may be compromised.

### BACKGROUND

Computer devices such as desktop or laptop computers, smartphones, tablets, and the like are routinely used to carry sensitive information that is to be accessed only by an authorized user of such device. Such sensitive information may include, for example, financial and healthcare information, business documents, identity documents, and the like. Access to current computer devices and information stored therein may be protected using various authentication methods including password authentication, multi-factor authentication, biometric authentication (e.g., a fingerprint scan, facial scan, iris scan, etc.), and the like to confirm that the operator of the computer device is the authorized user and not a bad actor (e.g., an identity thief, a corporate or government spy, and the like). However, the bad actor may be able to coerce the authorized user to provide authentication credentials or other access to the computer device and thereby the bad actor may gain access to the sensitive information stored on such device. Further, the authorized user of the device may not be able to erase or otherwise prevent the bad actor from accessing the sensitive information on the device without a risk of danger thereto. In addition, if the bad actor is able to coerce the authorized user to provide access to the device, a security service or operations center may not become aware of such coercion and unauthorized access and thus may be unable to timely protect the authorized user and the sensitive information until after the bad actor has already accessed the sensitive information stored on the device. If the bad actor is able to coerce the authorized user to provide access to the device, a security service or operations center may not become aware of such coercion and unauthorized access and thus be unaware if such protected documents have been modified to the bad actor's benefit and thus distributed as trusted data.

### SUMMARY

According to one aspect, a system to protect encrypted data on a computer device, wherein the encrypted data is encrypted using a master encryption key, includes an audio capture device and a controller having a processor and memory architecture. The controller is configured to acquire an audio recording using the audio capture device and analyze the audio recording to determine if the audio recording is associated with an authorized user saying a safe word and whether the authorized user said the safe word using a typical vocalization or a unique vocalization. The controller is further configured to delete the master encryption key if the audio recording is associated with the authorized user saying the safe word using the unique vocalization.

According to another aspect, a method to protect encrypted data on a computer device, wherein the encrypted data is encrypted using a master encryption key, includes acquiring an audio recording using an audio capture device of the computer device and analyzing the audio recording to determine if the audio recording is associated with an authorized user saying a safe word and whether the authorized user said the safe word using a typical vocalization or a unique vocalization. The method further includes deleting the master encryption key if the audio recording is associated with the authorized user saying the safe word using the unique vocalization.

Other aspects and advantages will become apparent upon consideration of the following detailed description and the attached drawings wherein like numerals designate like structures throughout the specification.

### BRIEF DESCRIPTION OF THE DRAWINGS

FIG. 1 is a partial planar view of an end-user device secured by a computer device protection system of the present disclosure;

FIG. 2 is a block diagram of the computer device protection system of FIG. 1;

FIG. 3 is a flowchart of steps undertaken by a training module of the computer device protection system of FIG. 1; and

FIG. 4 is a flowchart of steps undertaken by the safe word recognition module of the computer device protection system of FIG. 1.

### DETAILED DESCRIPTION

Disclosed herein is a computer device protection system (CDPS) that may be operated to protect data on an end-user device that may be a computer device such as, for example, a mobile device, a cell phone, a tablet, a desktop computer, and the like and to provide a distress beacon if an authorized user of the end-user device is threatened to provide a bad actor access to the end-user device. In particular, an encryption and decryption key pair is used to encrypt and thereafter decrypt, respectively, secure data stored on the end-user device. In some embodiments the encryption and decryption key pair may comply with the Advanced Encryption Standard (AES) and, per such standard, the encryption and decryption keys may be identical. It should be understood that the term “master encryption key” refers to an encryption and decryption key pair that may be used encrypt and decrypt data, respectively, or a single key (such as an AES compliant key) that may be used to both encrypt and decrypt data.

In some embodiments, the CDPS includes a training module that operates on an enterprise device associated with the end-user device. The enterprise device may be a computer device operated at a central operations center associated with the end-user device such as, for example, a command center, a corporate facility, a government facility, and the like. The training module obtains and stored on the enterprise device a voice signature of the authorized user that includes a recording of the authorized user saying a safe word (i.e., a single word or a phrase) selected by user and using a typical speech pattern associated with the authorized user. In addition, a unique or atypical vocalization of the safe word said by the authorized user is also obtained and stored on the enterprise device. Such unique vocalization may be selected by the user and include, for example, saying the safe word using one or more of an exaggerated or unusual cadence, an exaggerated or unusual tone, over-accented syllables, mis-accented syllables compared to the typical voice pattern of the authorized user. The training module develops a trained model to recognize the speech patterns of the authorized user and stores parameters associated with the trained model on the end-user device operated by the authorized user. Thereafter, the CDPS configures a trained model on the end-user device in accordance with the stored parameters, monitors recordings by an audio capture device of the end-user device, and uses the trained model to detect when the authorized user says the safe word using the unique vocalization. If the CDPS determines the authorized user has said the safe word with the unique vocalization, the CDPS deletes the master encryption key on the end-user device to prevent access to the secure data encrypted with the master encryption key and stored on the end-user device. In some embodiments, the CDPS replaces the master encryption key with a fake encryption key that allows access to non-sensitive data other than the secure data so the bad actor does not realize the master encryption key has been deleted and the secure data encrypted therewith is in inaccessible.

In some embodiments, when the CDPS determines the authorized user has said the safe word using the unique vocalization, the CDPS also generates and sends a beacon message from the end-user device to a server remote from the end-user device. Such server may be the enterprise device or another computer device located at or associated with a central operations center of an organization with which the authorized user and/or computer device are associated. Receipt of such message indicates to an operator of the server that the authorized user of the computer device is, at least, being threatened with coercion and the message may include identity and location information of the end-user device including, for example, an identifier associated with the end-user device and/or the authorized user, a current location (e.g., longitude and latitude or other Global Positioning System coordinates) of the end-user device, recent locations of the end-user device, an IP (or other network address) associated with the end-user device, and the like. In preferred embodiment, the beacon message is sent without any indication on the end-user device that such information has been transmitted to the server. The operator of the server may use information in the beacon message to deploy security personnel to locate and rescue the authorized user and/or potentially compromised end-user device. No record of such distress message having been sent is retained on the compromised end-user device after the beacon message is sent.

In some embodiments, the master encryption key may be stored on enterprise device (e.g., the server described above or another computer device associated with the organization) so that access to the sensitive data on the end-user device may be restored after such end-user device is recovered.

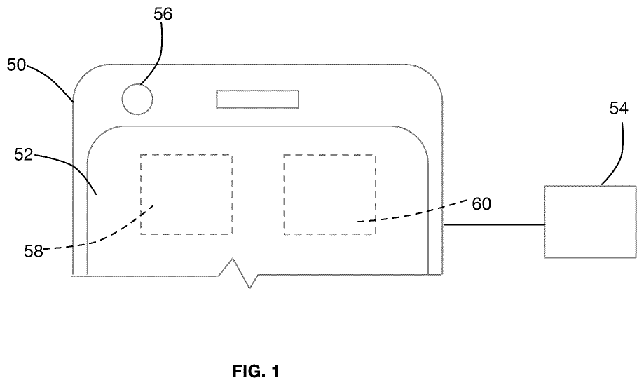

Referring to FIG. 1, the CDPS protects data on an end-user device 50 such as a mobile device (a smartphone, a tablet computer, and the like), a desktop computer, a laptop computer, and the like. The end-user device 50 may include a touch screen display 52 (or other input/output components) that enables the operator of the end-user device 50 to interact with the end-user device 50 to request and view information stored thereon or from a remote computer device to which the end-user device 50 is connected. The end-user device 50 may be connected to an enterprise device 54 by a communications network such as, for example, a wired or a wireless network, a cellular network, a public network such as the Internet, a private network such as a virtual private network, and the like. The end user device 50 does not require connectivity to delete the master encryption key to protect the sensitive data in a Denied, Disrupted, Intermittent, and Limited (DDIL) environment. The enterprise device 54 may include a remote server associated with the end-user device 50 and the CDPS operating on the end-user device 50 may communicate with such enterprise device 54 as described herein. The end-user device 50 also includes an audio capture device 56, for example, a microphone.

The end-user device 50 and the enterprise device 54 may have a processor and memory architecture comprising one or more processors 58 and one or more memory modules 60. The one or more memory modules 60 may have stored therein data and instructions to cause the one or more processors 58 to undertake the functions of the CDPS described herein. Further, the one or more memory modules 60 may have stored therein a master encryption key and encrypted sensitive data. Decryption of the encrypted sensitive data require the master encryption key and the CDPS controls access to the master encryption key so that decryption of the encrypted sensitive data by an operator other than the authorized user may be disabled. In some embodiments, data and instructions stored to cause the one or more processors 58 to undertake the functions of the CDPS may be encapsulated as one or more application program(s) (“app”) that can be downloaded and stored in the one or more memory modules 60.

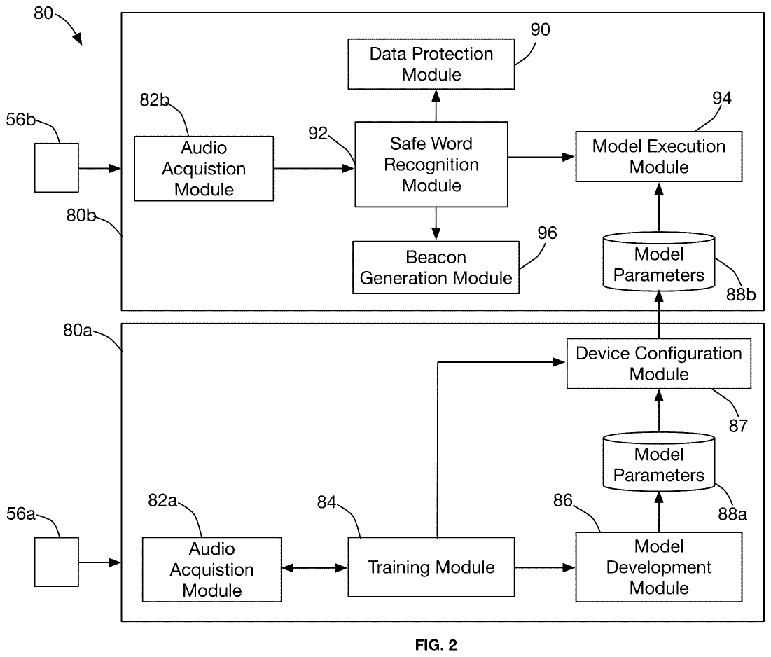

Referring to FIG. 2, in one embodiment, the CDPS 80 comprises a training and configuration component 80a and an end-user device monitoring component 80b. In such embodiment, the training and configuration component 80a operates on the enterprise device 54 to configure the end-user monitoring component 80b and includes an audio acquisition module 82a, a training module 84, a model development module 86, and a device configuration module 87. The training module 84 uses the audio acquisition module 82a to develop a voice signature associated with the authorized user using voice recordings acquired using an audio capture device 56a associated with the enterprise computer 54. In particular, the training module 84 prompts the authorized user to say the selected safe word and other words/phrases selected from a predetermined list of words and phrases or dictionary that are not the selected word using the typical speech pattern thereof. The training module 84 acquires at least one recording of the user saying the selected safe word using such typical speech pattern and at least one recording of the user saying each of a plurality of words/phrases that are not the safe word. Further, the training module 84 prompts the authorized user to select a unique speech pattern or vocalization with which the user will say the safe word if the user is threatened or under duress and say the selected safe word using such unique vocalization. The training module 84 acquires one or more recordings of the user saying the selected safe word using the unique vocalization of the safe word. In some cases, the training module 84 may prompt the user to repeat the safe word and the other words/phrases using the typical speech pattern of the user and to repeat the unique vocalization of the safe word multiple times and acquires one of a plurality of recordings of the authorized user's voice associated with each such prompt. Such recordings comprise a voice signature associated with the user. Prompting and recording the authorized user saying the safe word and other words/phrases multiple times in this manner allows the voice signature to include the natural variation of the user's speech pattern when the safe word is said using the typical and the unique vocalizations. The training module 84 stores the voice signature of the authorized user in the memory 60 of the enterprise device 54.

Thereafter, the training module 84 directs the model development module 86 to create a trained model that when presented with digital samples of an audio recording as an input produces one or more output values that represent probabilities that the input audio recording is that of the authorized user, the input recording is that of the authorized user saying the safe word and more particularly the input audio recording is that of the authorized user saying the safe word using the unique vocalization. In some embodiments, the model is a neural network having one or more convolutional layers and one or more dense layers, for example, to extract features and classify such features, respectively, from the input provided thereto. Inputs to the neural network may be digital values (e.g., samples) representing the input audio recording such as a frequency spectrum (e.g., amplitudes of frequencies) of the audio recording over a period of time, and the like. In some embodiments, the model development module 86 may load a model that is preconfigured in a generalized manner to recognize human speech patterns (i.e., words, phrases, vocalizations, etc.). Thereafter, the model development module 86 uses the recordings of the authorized user to further train such preconfigured model to more specifically distinguish recordings of the authorized user's speech from other audio recordings. In particular, the model development module 86 may select a first subset of the recordings that comprise the voice signature to train the model using, for example, backward propagation and the like. In addition, the model development module 86 may select a second subset of the recordings different than the first subset to assess the performance of the trained model. To assess the performance of the trained model, the model development module 86 may present each of the audio recordings comprising the second subset and other predetermined audio recordings as an input to the trained model and determine if the trained model generates output values that represent a correct classification of the input audio recording. The model development module 86 determines the trained model is trained sufficiently if the trained model is able to correctly classify an audio recording as a unique vocalization of the safe word with at least a predetermined accuracy. In some embodiments such predetermined accuracy may be at least between approximately 90% and approximately 95% for low-security applications, at least between approximately 95% and approximately 99% for moderate-security applications, and at least 99% for high-security applications. If the model development module 86 determines the model is not trained sufficiently, the model development module 86 may direct the training module 84 to prompt the authorized user for additional voice recordings of the safe word and additional words/phrases spoken with the typical vocalizations and safe word with the unique vocalizations, and thereafter performs additional training of the model.

In some embodiments, the model development module 86 may use speech recognition and analysis technologies apparent to one who has ordinary skill in the art instead of or in addition to the convolutional neural network described above. Such additional technologies include, for example, mel-frequency cepstral coefficients, a Gaussian mixture model or universal background model, iVectors, a deep neural network, probabilistic linear discriminant analysis, and the like. The model development 86 may also use one or more automatic speech recognition frameworks such as, for example, DeepSpeech, a Wav2Vec2 model, Hugging Face Transformers, and the like. The phrase “trained model” is used herein to refer to the convolutional neural network described above alone, the convolutional neural network used in combination with such additional technologies, or one or more of the additional technologies configured appropriately and used instead of the convolutional neural network, as would be apparent to one having ordinary skill in the art.

After the model development module 86 has developed the trained model that is able to correctly classify the audio recording presented as input thereto, the model development module 86 stores parameters (e.g., node weights, inter-node connections, vector representations, and the like) associated with the trained model in the model parameters data store 88a in the memory 60 of the enterprise computer 54.

After the model development module 86 has developed the trained model, the training module 84 directs the device configuration module 87 to configure the end-user device monitoring component 80b on the end-user device 50. Typically, training of the model is undertaken by the training and configuration component 80a in a controlled location (e.g., a protected government or corporate environment, a military command center, and the like) and the device configuration module 87 configured the end-user device 50 before such device is deployed from the controlled location.

The device configuration module 87 may download and install on the end-user device 54 one or more application program(s) associated with the end-user monitoring component 80b of the CDPS 80 and copy the model parameters from the data store 88a to a data store 88b in the memory 60 of the end-user device 50. The end-user device monitoring component 80b includes an audio acquisition module 82b, a data protection module 90, a safe word recognition module 92, a model execution module 94, and a beacon generation module 96.

In some embodiments, the device configuration module 87 may create and/or direct the data protection module 90 to create the predetermined unique master encryption key that may be used for file-based encryption and store such master encryption key in the memory 60 of the end-user device 50. In one embodiment, the master encryption key is stored in a hardware protected portion of the memory 60 or a trust zone (e.g., a trusted execution environment, a trusted platform module, and the like) so that such key may not be readily accessed or modified by an unauthorized operator of the end-user device 50.

Thereafter, the authorized user of the end-user device 50 may direct the data protection module 90 to encrypt sensitive data in one or more files stored on the end-user device 50 using the master encryption key and thus create an encrypted file. Because the contents of the encrypted file cannot be understood without first being decrypted by the master encryption key, the encrypted file may be stored in a non-protected portion of the memory 60 (i.e., outside the trust zone) and comingled with unencrypted files or data. Although, in some cases the data protection module 90 may store the encrypted file in protected memory (e.g., the trust zone noted above). The files having unencrypted sensitive data that correspond to the encrypted files may thereafter be deleted from the memory 60 (either manually by the authorized user or automatically by the data protection module 90).

Securing the sensitive data using the data protection module 90 may be undertaken in the controlled location or as needed after deployment of the end-user device 50. The end-user device monitoring component 80b of CDPS 80 also monitors audio recorded by the audio capture device 56 of the end-user device 50 after deployment, recognize a recording of the authorized user saying the safe word using the unique vocalization, and in response undertakes steps to protect the encrypted sensitive data stored in the memory 60, transmit the beacon message to the enterprise device 54 or another predetermined remote device, and thereafter erase from the end-user device 50 all traces of doing so.

In particular, the safe word recognition module 92 the safe word recognition module 92 directs the model execution module 94 to configure a trained model using the parameters stored in the data store 88b. Thereafter, the safe word recognition module 92 directs the audio acquisition module 82b to acquire a live audio recording using the audio capture device 56a of the end-user device 50, e.g., via a live recording application programmer interface (API) provided by the operating system of the end-user device 50. The API typically provides digitized samples of the recording that represent amplitudes of frequencies present therein over a period of time. The safe word recognition module 92 thereafter directs the model execution module 94 to provide the samples of live audio recording as an input to the trained model. As discussed above, in some embodiments, the outputs of such neural network indicate probabilities that the samples provided as inputs are associated with the authorized user, the authorized user saying the safe word, and the authorized user saying the safe word using the unique vocalization selected by the user. If these three probabilities are each greater than corresponding predetermined threshold probabilities, the safe word recognition module 92 determines that the authorized user has indeed said the safe word using the unique vocalization. In response, the safe word recognition module 92 directs the data protection module 90 to protect the data on the end-user device 50 and the beacon generation module 96 to generate and transmit the beacon message to the enterprise device 54. The data protection module 90 deletes the master encryption key. Further, in some embodiments, data protection module 90 replaces the master encryption key with a substitute or fake encryption key and stores non-sensitive data files (i.e., fake data) encrypted using the fake encryption key in the memory 60. The fake encryption key and the fake data are stored to mislead the bad actor who believes the end-user device 50 has been successfully compromised thereby.

In some embodiments, the data protection module 90 may develop first vector and/or other representations of the vocal signature of the authorized user and a second vector and/or other representation of the live recording obtained from the API, and compare such first and second vector and/or other representations using, for example, a cosine similarity and/or Euclidean distance therebetween, dynamic time warping, and the like to determine if the first and second vector and/or other representation are associated with the authorized user, the authorized user saying the safe word, and the authorized user saying the safe word with the unique vocalization. In addition, the data protection module 90 may use technologies such as acoustic feature comparison, phoneme-level analysis, and the like to determine if the live recording is that of the authorized user saying the safe word with the unique vocalization.

In some embodiments, one or both of the training and configuration component 80a and the end-user device monitoring component 80b may operate on the end-user device 50 instead of operating on the enterprise device 54 and the end-user device 50, respectively. In other embodiments, the audio acquisition module 82b may operate on the enterprise device 54 buy may be configured to acquire recordings using the audio capture device 56a of the end-user device 50.

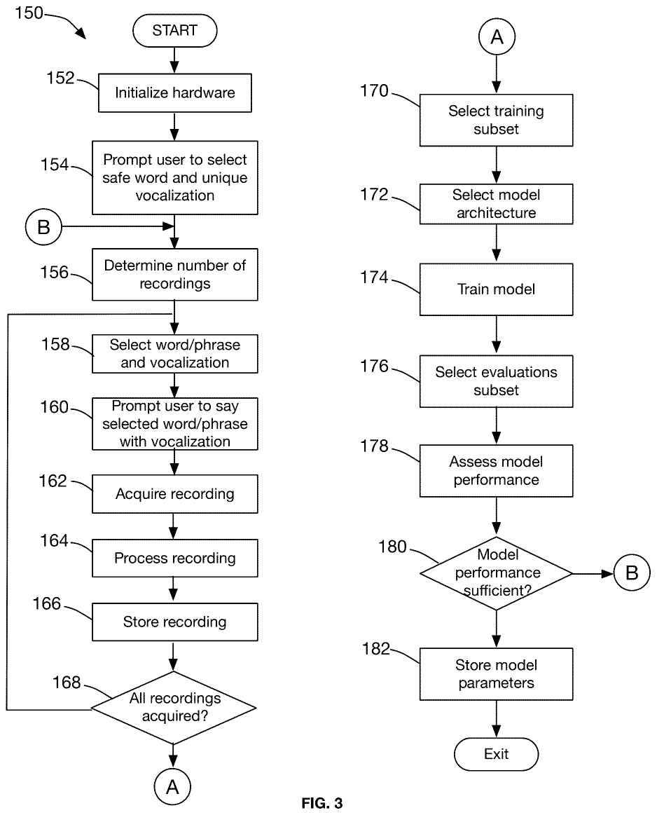

FIG. 3 is a flowchart 150 that shows steps undertaken by the training and configuration component 80a of CDPS 80 to develop a trained model that may be used to determine when the authorized user has said the safe word using a unique vocalization. Referring to FIGS. 1-3, at step 152, the CDPS 80 initializes, for example, the audio capture device 56a and hardware/software to enable the audio acquisition module 82a to use the audio capture device 56a of the enterprise device 54 to record audio. At step 154, the training module 84 prompts the authorized user, for example, by displaying a message on the touchscreen display 52, to select a safe word and a unique vocalization of the safe word that the user will use when in distress or under threat. At step 156, the training module 84 selects a quantity of recordings of the user saying each safe word using the typical and unique vocalizations that are to be acquired. In some embodiments, such number of recordings may be between 5 to 10 recordings of each word or phrase said by the user in various conditions. For embodiments that require moderate to high accuracy, such number of recordings may be between 50 to 100 and may be even between 100 and 200 or more in other embodiments.

At step 158, the training module 84 selects, for example, randomly, whether to acquire a recording of the authorized user saying the safe word using the typical vocalization, the safe word using the unique vocalization, or another word/phrase that is not the safe word. At step 160, the training module 84 prompts the authorized user to say the word or phrase selected at step 158 using the vocalization also selected at step 158. At step 162, the training module 84 directs the audio acquisition module 82a to acquire a recording of the authorized user saying the selected word or phrase using the using the selected vocalization and receives digital samples of the acquired audio recording. In some embodiments, the training module 84 may, at step 164, analyze and process the received recording to, for example, trim any leading or trailing portions of the recording that are substantially silent, remove background or other noise from the recording, remove frequencies outside of a frequency band humans are able to generate, and the like. In other embodiments, such processing of the recording may be undertaken by the audio acquisition module 82a before supplying the audio recording to the training module 84, or may be undertaken by the audio acquisition hardware/software of the enterprise device 54 and/or a service or driver provided by the operating system of the enterprise device 54.

At step 166, the training module 84 stores the recording (i.e., the digital samples associated with the recording) in the memory 60 of the enterprise device 54. The recording that is stored may be the recording after any optional processing described in connection with step 164 have been undertaken or the recording acquired using the audio capture device 56 if such optional processing is not undertaken.

In some embodiments, the training module 84 may develop additional versions of the recording acquired at step 162 by applying pitch shifts, adding noise, changing the speed, and the like and store such additional versions as additional recordings, also at step 166. Such additional recordings may also be used to develop the trained model.

At step 168, the training module 84 determines if the quantity of recordings determined at step 156 have been acquired and, if so proceeds to step 170. Otherwise, the training module 84 proceeds to step 158 to acquire a subsequent recording.

At step 170, the model development module 86 selects a training subset of the recordings acquired and stored by undertaking steps 158 through 166 to use to develop the trained model. At step 172 selects a model architecture (i.e., number of input nodes, convolutional nodes, dense nodes, output nodes, and interconnected node layers if the model is a neural network, etc.) and configures an untrained model in accordance with the selected model architecture. For example, the model development module 86 may determine a maximum number of samples in the recordings stored at step 166 and select a model architecture that has at least as many input nodes as such maximum number. As discussed above, the untrained model selected at step 172 may be a model that is preconfigured to for speech recognition and that will be further trained to recognize the speech of the authorized user.

At step 174, the model development module 86 trains the untrained model configured at step 172. In particular, the model development module 86 iteratively supplies each recording of the training subset to the untrained model, determines a difference between the output generated by the untrained model and an expected output, and uses backpropagation (or other techniques apparent to one having ordinary skill in the art) to adjust the weights and other parameters of the model to reduce such difference in subsequent iterations. The model development module 86 undertakes such training until the model is sufficiently trained to accurately classify a predetermined proportion of the recordings of the training subset.

Thereafter, the model development module 86 selects an evaluation subset of the recordings stored at step 166 that is different than the training subset at step 176. At step 178, the model development module 86 presents each recording of the evaluation subset at the input of the trained model developed at step 174 and evaluates the output generated in response determine a portion of the evaluation subset that is correctly categorized by the trained model. At step 180, the model development module 86 determines if the portion correctly categorized is at least predetermined portion of the evaluation subset and, if so, proceeds to step 182. Otherwise, the model development module 86 proceeds to step 156 to determine how many additional recordings should be acquired, acquire such additional recordings, and develop another trained model.

At step 182, the model development module 86 stores parameters of the trained model in the data store 88a of the enterprise device 54 and directs the device configuration module 87 to store such parameters in the data store 88b of the end-user device 50. In addition, the device configuration module 87 may undertake further configuration of end-user device 50 as described above, also at step 182.

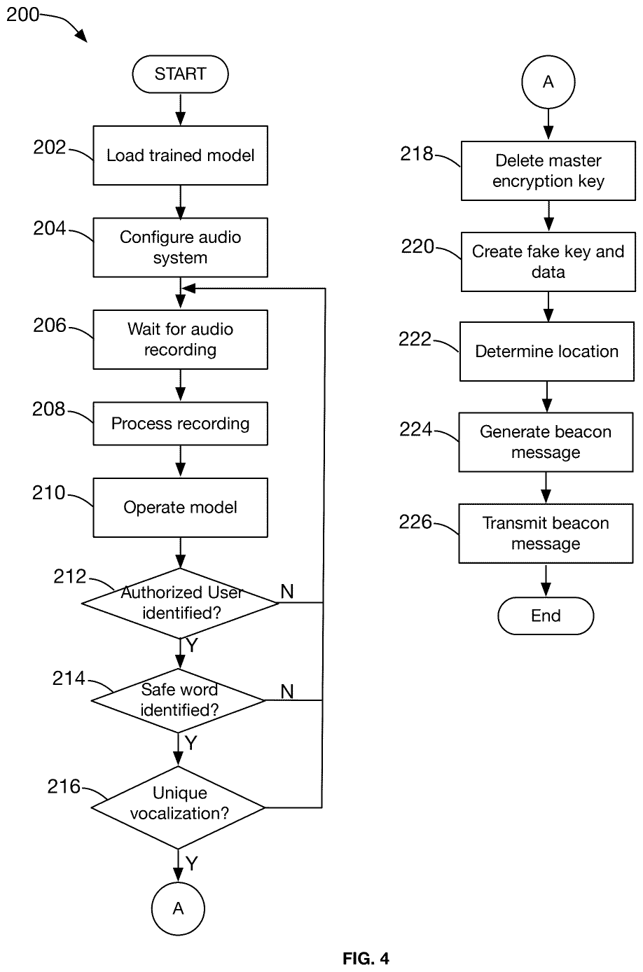

FIG. 4 is a flowchart 200 of steps undertaken on the end-user device 50 by end-user device monitoring component 80b of the CDPS 80. Such steps are undertaken after the trained model has been developed and parameters associated with the trained model have been stored on the end-user device 50 as described above to monitor audio in the ambient environment of the end-user device 50 and protect the end-user device 50 when necessary. At step 202, the safe word recognition module 92 directs the model execution module 94 to configure a trained model in accordance with the model parameters stored in the data store 88b. At step 204, the safe word recognition module 92 directs the audio acquisition module 82 to configure the audio subsystem of the operating system of the end-user device 50 to monitor using the audio capture device 56b the ambient environment for the occurrence of sounds that include frequencies in the human vocal range, record such sounds, and provide such recordings to the audio acquisition module 82b. The safe word recognition module 92 further directs the audio acquisition module 82b to generate a message or an interrupt when such recording is received.

At step 206, the safe word recognition module 92 waits to receive the message or the interrupt that an audio recording is available. As discussed above, the audio recording comprises a plurality of digital samples that represent the amplitudes of frequences sensed by the audio capture device 56b during a period of time. The safe word recognition module 92 processes the recording as described above in connection with step 164 (FIG. 3) at step 208. Thereafter, the safe word recognition module 92 invokes the model execution module 94 to evaluate the digital samples. In response, at step 210, the model execution module 94 executes the trained model with the digital samples as inputs to the trained model. As discussed above, the outputs of the trained model are probabilities that the digital samples are representations of the authorized user saying the safe word and the authorized user saying the safe word using the unique vocalization selected thereby.

At step 212, the safe word recognition module 92 analyzes the outputs generated by the trained model to determine the probability the audio recording is of the authorized user and the safe word recognition module 92 proceeds to step 214 if such probably exceeds a predetermined threshold. Otherwise, the safe word recognition module 92 returns to step 206 to wait for another audio recording.

At step 214, the safe word recognition module 92 analyzes the outputs generated by the trained model to determine the probability that the audio recording is of the authorized user saying the safe word. If such probability exceeds a predetermined threshold, the safe word recognition module 92 proceeds to step 216. Otherwise, the safe word recognition module 92 returns to step 206 to wait for another audio recording.

At step 216, the safe word recognition module 92 determines, in accordance with the outputs generated by the trained model, a probability that the audio recording acquired at step 206 is a representation of the authorized user using the unique vocalization to say the safe word. If such probability exceeds a predetermined threshold the safe word recognition module 92 proceeds to step 218. Otherwise, the safe word recognition module 92 returns to step 206.

At step 218, the safe word recognition module 92 invokes the data protection module 90 to protect the encrypted sensitive data stored on the end-user device 50. In response, also at step 218, the data protection module 90 deletes the master encryption key stored in the memory 60 of the end-user device 50. In addition, at step 220, the data protection module 90 stores a fake master encryption key and fake encrypted data encrypted using the master encryption key in the memory 60. In some embodiments, an original version of such fake master encryption key is previously stored in a portion of the memory 60 that is outside the trust zone of end-user device 50. In such embodiments, the data protection module 90 creates a duplicate of the fake master encryption key in the trust zone and deletes the original version of the fake master encryption key to mislead the bad actor into believing the fake master encryption key in the trust zone is used to protect sensitive data.

Thereafter, the safe word detection module 92 invokes the beacon generation module 96. In response, the beacon generation module 96, at step 222, the beacon generation module 96 determines location information associated with where the end-user device 50 is presently located and, optionally, one or more previous locations in the past. For example, the beacon generation module 96 may determine such location in accordance GPS or other location coordinates supplied by a location service of by the operating system of the end-user device 50. Thereafter, at step 224, the beacon generation module 96 creates a beacon message that includes, for example, an identifier associated with the authorized user, an identifier associated with the end-user device 50, a time stamp, and the location information determined at step 220, and transmits such beacon message to the enterprise device 54 or another predetermined device remote from the end-user device 50, at step 226. Such message may be transmitted, for example, using one or more of an email, an SMS or text message, a message transmitted to a communications port monitored by a process operating on the enterprise device 54, and the like. Further, such message may be transmitted over a private network (e.g., a virtual private network, a military network, and the like) and/or a public network (e.g., a cellular network, the Internet, and the like). In addition, the beacon generation module 96, also at step 226, erases or deletes any traces (data, log entries, and the like) from the end-user device 50 that the beacon message has been sent. Thereafter, the safe word recognition module 92 exits. If the master key deletion is successful by the authorized end user in a DDIL environment, the beacon message may be transmitted once connectivity is restored.

It should be apparent to those who have skill in the art that any combination of hardware and/or software may be used to implement components of the CDPS 80 described herein. It will be understood and appreciated that one or more of the processes, sub-processes, and process steps described in connection with FIGS. 2-4 may be performed by hardware, software, or a combination of hardware and software on one or more electronic or digitally-controlled devices. The software may reside in a software memory (not shown) in a suitable electronic processing component or system such as, for example, one or more of the functional systems, controllers, devices, components, modules, or sub-modules depicted in FIGS. 2-4 The software memory may include an ordered listing of executable instructions for implementing logical functions (that is, “logic” that may be implemented in digital form such as digital circuitry or source code, or in analog form such as analog source such as an analog electrical, audio, or video signal). The instructions may be executed within a processing module or controller (e.g., processing device 58, the audio acquisition module 82, the training module 84, the model development module 86, the device configuration module 87, the data protection module 90, the safe word recognition module 92, and the beacon generation module 96), which includes, for example, one or more microprocessors, general purpose processors, combinations of processors, digital signal processors (DSPs), field programmable gate arrays (FPGAs), application-specific integrated circuits (ASICs), and/or graphics processing units (GPUs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

Depending on certain implementation requirements, the embodiments described can be implemented in hardware and/or in software. The implementation can be performed using a non-transitory storage medium such as a digital storage medium, for example, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the present disclosure comprise a data carrier having electronically readable control signals, which are capable of cooperating with a processor, a controller, or a programmable computer system, such that one of the methods described herein is performed.

Generally, embodiments disclosed herein can be implemented as a computer program product with a program code, the program code being operative for performing one of the methods when the computer program product runs on a computer. The program code may, for example, be stored on a machine-readable carrier.

Other embodiments comprise the computer program for performing one of the methods described herein, stored on a machine-readable carrier.

In other words, an embodiment, therefore, may include a computer program having a program code for performing one of the methods described herein, when the computer program runs on a processor, a controller, and/or a computer.

A further embodiment of the system described herein is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitory. A further embodiment of the present invention is an apparatus as described herein comprising a processor and the storage medium.

A further embodiment of the system described herein is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a computer device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

While particular embodiments of the present invention have been illustrated and described, it would be apparent to those skilled in the art that various other changes and modifications can be made and are intended to fall within the spirit and scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

I claim:

1. A system to protect encrypted data on a computer device, wherein the encrypted data is encrypted using a master encryption key, the system comprising:
an audio capture device; and
a controller having a processor and memory architecture and configured to:
acquire an audio recording using the audio capture device;
analyze the audio recording to determine if the audio recording is associated with an authorized user saying a safe word and whether the authorized user said the safe word using a typical vocalization or a unique vocalization; and
delete the master encryption key if the audio recording is associated with the authorized user saying the safe word using the unique vocalization.

2. The system of claim 1, wherein the controller is configured to prompt the authorized user to select the safe word and the unique vocalization.

3. The system of claim 2, wherein the audio recording comprises a first audio recording and the controller is further configured to receive a second audio recording of the user saying the safe word using the typical vocalization and a third audio recording of the user saying the safe word using the unique vocalization.

4. The system of claim 3, wherein the controller is configured to develop a trained model using the second audio recording and the third audio recording so that the trained model determines if the first audio recording represents the authorized user saying the safe word using the unique vocalization when trained model is supplied with the first audio recording as an input.

5. The system of claim 4, wherein the trained model comprises a neural network.

6. The system of claim 1, wherein the master encryption key is stored in a trust zone associated with the computer device.

7. The system of claim 6, wherein the controller is configured to develop a fake encryption key and store the fake encryption key in the trust zone after deleting the master encryption key.

8. The system of claim 1, wherein the controller is configured to develop and transmit a beacon message to a server remote from the computer device if the controller determines the authorized user said the safe word using the unique vocalization, wherein the beacon message includes location information associated with the computer device.

9. The system of claim 1, wherein the controller is further configured to develop the encrypted data by encrypting data with the master encryption key using file-based encryption.

10. The system of claim 9, wherein the encrypted data is stored in a portion of the memory outside the trust zone and comingled with unencrypted data.

11. A method to protect encrypted data on a computer device, wherein the encrypted data is encrypted using a master encryption key, the method comprising:
acquiring an audio recording using an audio capture device of the computer device;
analyzing the audio recording to determine if the audio recording is associated with an authorized user saying a safe word and whether the authorized user said the safe word using a typical vocalization or a unique vocalization; and
deleting the master encryption key if the audio recording is associated with the authorized user saying the safe word using the unique vocalization.

12. The method of claim 11, further including prompting the authorized user to select the safe word and the unique vocalization.

13. The method of claim 12, wherein the audio recording comprises a first audio recording and further including receiving a second audio recording of the user saying the safe word using the typical vocalization and receiving a third audio recording of the user saying the safe word using the unique vocalization.

14. The method of claim 13, wherein further including a trained model using the second audio recording and the third audio recording so that the trained model determines if the first audio recording represents the authorized user saying the safe word using the unique vocalization when trained model is supplied with the first audio recording as an input.

15. The method of claim 14, wherein the trained model comprises a neural network.

16. The method of claim 11, further including storing master encryption key in a trust zone associated with the computer device.

17. The method of claim 16, further including developing a fake encryption key and storing the fake encryption key in the trust zone after deleting the master encryption key.

18. The method of claim 11, further including developing and transmitting a beacon message to a server remote from the computer in response to determining the authorized user said the safe word using the unique vocalization.

19. The method of claim 11, further including developing the encrypted data by encrypting the data with the master encryption key using file-based encryption.

20. The method of claim 11, further including storing the encrypted data in a portion of the memory outside a trust zone and comingled with unencrypted data.
